(19) United States
(12) Patent Application Publication
(10) Pub. No.: US 2016/0182471 A1
(43) Pub. Date: Jun. 23, 2016

(54) NETWORK SECURITY BROKER

(71) Applicant: 1E LIMITED, London (GB)

(72) Inventors: James WILSON, London (GB); Jonathon SCHNITTGER, London (GB)

(21) Appl. No.: 14/972,869

(22) Filed: Dec. 17, 2015

(30) Foreign Application Priority Data
Dec. 18, 2014 (GB) 1422661.7

(51) Int. Cl. H04L 29/06; H04L 9/08; H04L 9/14

(52) U.S. Cl. CPC H04L 63/06; H04L 63/105; H04L 9/14; H04L 9/0861

(57) ABSTRACT

Certain methods and systems are described to provide security for sending and receiving data over unsecured networks. In an example a security broker (260) is provided between a first network (210) and a second network (220) where the security level of the first network is different from the security level of the second network. A user in the first network is given control over the level of security to be applied to data being supplied to an application (240) in the second network. The security broker (260) is arranged to supply data encrypted using a security scheme to the application (240) in the second network (220) and to supply decrypted data using the security scheme to a computing device associated with the first network (210).

### CROSS-REFERENCE TO RELATED APPLICATIONS

This application claims priority under 35 U.S.C. §119(a) to UK Patent Application No. GB 1422661.7, filed on Dec. 18, 2014, the entire content of which is hereby incorporated by reference.

### BACKGROUND OF THE INVENTION

1. Field of the Invention

The field of invention is application data security. In particular, the present invention relates to the security of data that needs to be sent and/or received over one or more unsecure networks.

2. Description of the Related Technology

In recent times there has been a rise in applications that are provided on remote server computer devices that are accessed over the Internet. This configuration is commonly referred to as “cloud computing”. The Internet, in this context, comprises a number of interconnected networks that operate using the Internet protocol suite, e.g. Transmission Control Protocol/Internet Protocol (TCP/IP). These networks may be private and/or public and typically have differing levels of control, oversight and/or security.

Cloud computing services such as Software-as-a-Service (SaaS) and more generally utility-based computing and outsourcing of computer functions have grown in popularity with consumers and enterprises alike, due to the availability of high bandwidth and the prevalence of mobile communication technology. This has had enormous benefits, giving users a much larger range of applications and services than were previously available. However, use of cloud computing has increased security concerns, leading many to question the long term viability of cloud computing as an alternative to conventional computing.

For example, most users access these applications from some form of private or controlled network. For example, this may be a home or office network that is protected by one or more security features such as firewalls and domain controllers that prevent unauthorized and/or malicious access to data and devices on this network. However, in many cases, the applications lack the same level of trust and security. For example, the application may be under the control of a party that is different from the party that controls the user network. Additionally, a level of security applied by the application may be different from a level of security applied within the user network. This presents a security threat to the user network since an application may expose sensitive user information in an insecure setting and/or provide access to user devices within the secured user network.

### SUMMARY

Aspects of the present invention are set out in the appended claims.

### BRIEF DESCRIPTION OF THE DRAWINGS

FIG. 1 is a schematic diagram of a network environment;

FIG. 2 is a schematic diagram showing a security broker in a network environment according to one or more embodiments of the present invention;

FIG. 3 is a schematic diagram of a security broker according to one or more embodiments of the present invention;

FIG. 4 is a schematic diagram of an application being accessed through a security broker according to one or more embodiments of the present invention;

FIG. 5 is a flow chart showing a method of configuring a security broker according to one or more embodiments of the present invention;

FIG. 6 is a flow chart showing a method of supplying encrypted data to an application according to one or more embodiments of the present invention;

FIG. 7 is a flow chart showing a method of supplying a computing device with unencrypted data according to an example; and

FIG. 8 is a schematic diagram showing an exemplary computer system.

### DETAILED DESCRIPTION OF CERTAIN INVENTIVE EMBODIMENTS

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Certain examples described herein provide a security broker that improves security for users accessing applications across unsecure and/or untrusted networks, e.g. for cloud computing applications. A security broker is typically a configured device, e.g. custom software implemented on networked-coupled hardware, which may be used to enhance security for users accessing applications that are under a different level of security control from a network containing the user computing device. This can prevent third-party access to confidential data stored by the application yet allow a user to access the large range of cloud computing applications. In certain examples described herein, a security broker is arranged to receive data from the user, process that data to implement one or more security features, and then forward the data on to the application. Similarly data is received from the application at the security broker and this data may be forwarded, after some processing, to the user. These security features may comprise encryption and/or decryption of data.

Example Network Environment

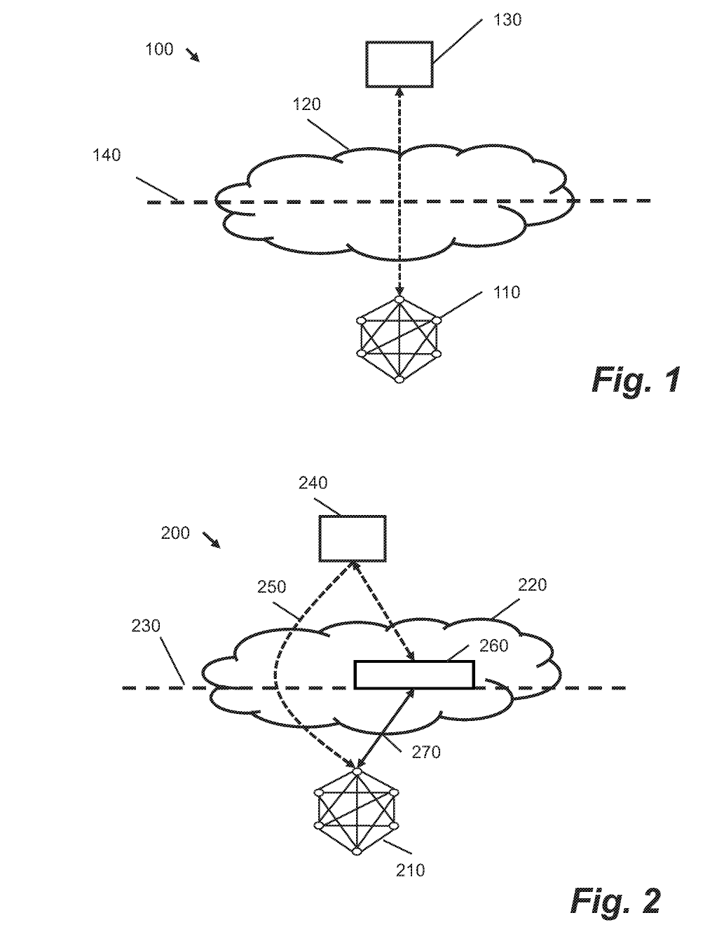

FIG. 1 is a simplified schematic diagram showing a network environment 100 according to an example. The network environment comprises a first network 110, a second network 120 and an application 130. The application 130 is accessible from a user computing device in the first network 110 by way of the second network. The first network 110 has a first level of security and the second network 120 has a second level of security different from the level of security of the first network 110. The line 140 is illustrative of a distinction or boundary between the first network 110 and second network 120.

For example, first network 110 may comprise a private network such as a local area network or virtual private network. The first network 110 may comprise one or more networks that are under control of a first party, e.g. may comprise a series of local area networks coupled by virtual private network connections implemented over one or more wide area networks. Network boundaries of the first network 110 may be defined by one or more network security devices, such as firewalls that monitor and filter network packets. The first network 110 may implement one or more security systems that manage these network security devices. The second network 120 may be a public network, for example a public Wi-Fi network, a shared backbone link and/or a portion of an Internet Service Provider's network. The second network 120 is not under the control of the first party, e.g. it may have no control and/or may be controlled by one or more third parties. These third parties may be untrusted by the first party. For example, the first party may not be able to ensure that packets will not be intercepted and/or inspected when travelling over the second network 120. In this case line 140 represents a division between the private and public networks where the latter is typically less secure, i.e. represents a boundary between a secured network and an unsecured network. According to one example, line 140 may represent an actual security boundary, such as a firewall or gateway between a first and second network. The first and second networks may be physical or virtual.

In FIG. 1 application 130 is implemented by at least one server computing device in the second network 120 that is accessible from a user computing device in the first network 110 through the second network 120. Application 130 is arranged to send and receive data via the second network 120, e.g. to or from the first network 110. According to one example, a user computing device on the first network 110 may access the application 130 by way of a client-side or browser-based application that is associated with application 130. In certain examples, the application 130 may receive data from the first network 110 independent of any explicit user interaction, such as monitoring and/or measurement data associated with use of computing devices on the first network 110.

In the example of FIG. 1, the application 130 cannot be trusted as it resides on, e.g. is accessed via, the second network. In such instances, there is a risk that data may be intercepted and or accessed when being sent to and from the application 130. There is also a risk that the application 130 may expose confidential data. For example, even if the first network 110 comprises one or more security systems and/or security devices to prevent unauthorized and/or malicious access to data, these systems and/or devices cannot be trusted to be provided on the second network 120 and/or in relation to the application 130. Additionally, the application 130 may manage and/or store data for a plurality of users, including those outside the first network 110. Hence, not only may it be a target for a potential malicious attack, other users may be able to access portions of the application 130 such as cryptographic keys or system data. This presents a security risk for data that is secure on the first network, e.g. data associated with a user computing device on the first network 110.

Security Broker Example

FIG. 2 shows a simplified schematic diagram, according to an example, of a networking environment 200 similar to that shown in FIG. 1. In this case, a first network 210 and second network 220 are present. As in FIG. 1, line 230 represents a security boundary between networks that is illustrative of differing security levels between the first network 210 and the second network 220. An application 240 implemented on second network 220 is being accessed from the first network 210. FIG. 2 shows, according to an example, an insecure connection 250 between application 240 and first network 210. In the context of this disclosure the first network has a first security level, the second network has a second security level and the security levels between first and second networks are different. For example, the connection may provide no additional security means, for example in the form of an encrypted and/or authenticated connection. In one case, the second network 220 may comprise at least a server computing device implementing application 240. In this case, the second network 220 may have a different level of security in that the server computing device is not under the control of the first network 210. For example, even if a communication channel between the first network 210 and the second network 220 is secured, the second network 220 may still be less secure through this lack of control. The second network 220 provides means for the application to send data to the user computing device in first network 210, for example, a browser plugin portion of the application.

In comparison to the networking environment 100 shown in FIG. 1, environment 200 is augmented by a security broker 260. Security broker 260 is coupled to the first network 210 via a secure connection 270 and may send information to, and/or receive information from, the application 240 in the second network 220. As such security broker 260 may be said to be implemented on the boundary 230 between the first network 210 and the second network 220. Secure connection 270 may be a connection which is secured cryptographically and/or physically.

The security broker 260 may comprise a physical network device such as an embedded computing device and/or may comprise a virtual network device and/or function. For example, the security broker 260 may comprise computer program code in the form of firmware or embedded software that is implemented by a processor of the network device. In other cases, e.g. wherein the security broker 260 is a virtual network device, the security broker 260 may be implemented by computer program code that is arranged to be processed by one or more processors of a server computing device, e.g. in certain cases this may be performed via one or more levels of virtual machines.

The security broker 260 may be implemented by a server computing and/or embedded device that is physically coupled to the first network 210, e.g. it may be coupled via an Ethernet connection to a local area network forming at least part of the first network 210. In this case, the security of secure connection 270 is at least in part provided by controlling the physical access to a physical network connection. In this case, the security broker 260 may also be arranged to send network traffic over the second network 220, e.g. may be communicatively coupled to a gateway or firewall in the first network 210 that allows access to the second network 220. This access may be provided by one or more intermediate networks, e.g. one or more intermediate wide and/or local area networks. For example, the server computing device that implements (“hosts”) the application 240 may be resident in a geographically remote data center.

In one case, application 240 may be being accessed from a third network (not shown in FIG. 2). A request from the third network may be received by the security broker 260. For example, a user of a computer device in the first network 210 may be working from home or accessing the application 240 from a mobile device. In this case the security broker may receive the request and generate a request for authentication of the user that is sent to a security system of the first network 210. If the user is authenticated via the first network 210 then the security broker 260 may be arranged to forward the request for data to application 240 and supply data from the application 240 to the user. The data may be decrypted by the security broker 260 or decrypted locally based on permissions supplied by security broker 260.

In one example, the security broker 260 may be physically remote from the first network 210 but may still be virtually coupled to the first network 210. For example, secure connection 270 may be implemented using a standardized protocol for secure communication such as TLS/SSL or SSH. This may implement a virtual private network between a server computing and/or embedded device providing the security broker 260 and the first network 210. In another case, secure connection 270 may be implemented at a packet level using a protocol suite such as IPsec. In this case the security broker 260 may be hosted by a trusted third party. This trusted third party may comprise, for example, a certificate authority.

In the example of FIG. 2, security broker 260 is arranged to use configuration data supplied by the application 240 and security data for one or more of users of a user computing device on the first network 210 to configure a security scheme. In this example, the security scheme comprises an encryption scheme. In this case “encryption scheme” refers to a configuration and/or selection of one or more cryptographic algorithms for one or more of key generation, encryption and decryption. An encryption algorithm takes a message and a key and outputs a ciphertext and a decryption algorithm takes a ciphertext and a key and outputs a message. This enables unencrypted data (i.e. plaintext) to be encrypted and/or encrypted data (i.e. ciphertext) to be decrypted. This encryption scheme may be based on private or public key encryption schemes. For example, the encryption scheme may implement one or more of the Data Encryption Standard (DES), the Advanced Encryption Standard (AES), RSA encryption, and Elliptic Curve Cryptography (ECC), amongst others.

In this example, the configuration data supplied by the application 240 may comprise data record definitions. The configuration data may be supplied in response to one or more commands received at an interface of the application 240, e.g. an application programming interface (API) of the application 240. These data record definitions may specify one or more properties that define how data is stored by the application 240. For example, the application 240 may store data in a data store according to a schema. This may define properties such as, amongst others, field lengths, field names, record names, table names, field types, supported and/or suggested encryption, hashing levels and whether the field stores user derived data. The configuration data may also comprise data indicating the security roles and/or privileges that the application supports. In certain cases this may form part of the data record definitions and/or may be accessible by a query to the API of the application 240.

The application may comprise an entitlement solution, e.g. to control and monitor the configuration of a network. In one case the application may comprise AppClarity® as supplied by 1E Limited of London, UK and 1E Inc. of New York, USA. In this case, the application may store data associated with computing devices on the first network. This data may indicate a configuration of one or more of said computing devices, such as a hostname, a serial number, an operating system, a manufacturer, software installed (e.g. product name, vendor, version and edition) and a BIOS identifier. In this case, the data record definitions may indicate which data is stored as well as which data is to be, or recommended to be, encrypted. For example, a data record definition may indicate that the hostname, serial number and operating system fields are to be encrypted, but not the manufacturer and BIOS identifier fields. If data is recommended to be encrypted this may be confirmed by a system user of the first network 210 using an interface of the security broker 260. In the context of hardware and software configuration data for the first network, the identifying details of each of the devices on the first network may be secured, e.g. encrypted. These details may comprise one or more of, amongst others: device hostname; IP address; media access control (MAC) address; serial number; domain; and fully-qualified domain name. In this context, software details relating to a device on the first network may also be secured, e.g. encrypted, so as to prevent disclosure of vulnerable systems data that may be used in any cyber-attack. For example, the configuration data may indicate missing operating system patches that may be exploited by a malicious party, e.g. to “hack into” or take control of devices on the first network. This data may thus be secured.

In this example, the security data of the one or more users is indicative of a set of permissions applied on the first network 210 that restrict one or more actions that are available to the one or more users, e.g. user identities for these users. For example, these permissions may be applied by a security system used on the first network 210 to secure access. A security system may be based on Active Directory® and/or open authorization standards (OAuth). In one case, the security data may be associated with user and/or group authentication on the first network, e.g. using a domain controller. Similar to the configuration data, in certain cases the security data may be accessed using an interface of a security system implemented on the first network 210, e.g. an API. For example, the security broker 260 may be arranged to perform one or more Lightweight Directory Access Protocol (LDAP) queries on an Active Directory® to determine group membership on the first network 210. In other case a security system user on the first network 210 may be provided by a third party system such as Amazon Identity Access Management®. Similarly, remotes queries may be used to obtain application, operating system and/or attributes of users and/or groups on the first network 210. In one case the security broker 260 may be configured to authenticate a user using a security system of the first network 210 and may the authenticated user to one or more of parameters for an encryption scheme and permissions for the application 240.

In one implementation, communications between the security broker 260 and the application may configure routing of requests via the security broker 260. For example, one or more commands received at an interface of the application 240 from the security broker 260 may register the security broker 260 with the application 240. Details of the application 240, e.g. a uniform resource locator for an API and/or one or more credentials may be initially retrieved using a directory service or using information entered by a user. Alternatively, application 240 may be configured to communicate with security broker 260 to register itself as an available application configured to supply configuration data. In any case, in this implementation, both the security broker 260 and the application store information identifying and/or authorizing each other such that routing via the security broker 260 may be achieved.

In one case, security parameters may be selected for one or more user identities such that data identified in the data definition records is encrypted using a high level of encryption but a low or poor level of hashing, e.g. a level of hashing with a high collision rate. A high collision rate means that more hashes will match for different outputs e.g. operating system producers Microsoft®, Monkey and Apple® may all produce the same hash (e.g. AABBCCDDEEFF). This may be used so it is not possible to properly identify a value by its hash.

Once an encryption scheme has been configured the security broker 260 is arranged to encrypt data originating from the user computing device on the first network 210 according to the encryption scheme and send the encrypted data to the application 240 for storage. According to one example, the encryption scheme is implemented at the security broker 260 itself; however other examples are possible, in particular a separate agent may implement the encryption scheme, encrypting data on behalf of the security broker. In the latter case the agent may comprise a dedicated encrypting entity at the user computing device, implementing the encryption scheme as configured by the security broker. Security broker 260 is further arranged to decrypt data originating from the application according to the encryption scheme and send the decrypted data to the user computing device. Again this may be performed by the security broker 260 itself or the security broker 260 may be arranged to configure an external device, such as an agent on a user computing device.

In one case, the security broker 260 configures the encryption scheme by first configuring it to comply with the constraints indicated in the configuration data from the application 240. For example, the security broker 260 may process the configuration data and record which fields indicated in the configuration data contain user and/or sensitive data that may require encryption. Parameters of the encryption scheme may be set that define the encryption to be provided for each data field. For example, in receipt of configuration data indicating a data field with a field type of double (e.g. eight bytes in length), the security broker 260 may configure the encryption scheme to provide an encrypted output in the form of an eight byte number. Alternatively, if a data field may be encrypted by one of 64-bit, 128-bit, 256-bit and 512-bit encryption, the level set by the encryption scheme may be defined based on a global or local level selected by a system administrator and/or mapped from a defined minimum level in the security data, e.g. the security data map comprise a security policy with a value indicating that a minimum level of security is 256-bit encryption. The security broker 260 may also be arranged to change a default and/or suggested level of security for the application 240 indicated in the configuration data; e.g. DES may be suggested but the security broker 260 may configure the encryption scheme to use an optional level of AES security. In one case an encryption scheme may comprise a hashing scheme. It should be noted that the term encryption scheme applies to any cryptographic scheme and covers at least one or more of encryption and decryption.

Similarly, the roles and/or privileges available to users of the application 240 may be mapped to equivalent roles and/or privileges that form part of a user identity on the first network 210. This mapping may be set by a system administrator that is presented with available roles and/or privileges from each of the application 240 and the first network 210. Alternatively, the mapping may be performed automatically by the security broker 260, e.g. based on security level mapping and/or defined security constraints. For example, a user of the first network 210 that is not allowed access to sensitive data on the first network may be mapped to a lowest security level of user for the application 240; likewise, a system administrator of the first network 210 may be mapped to a highest security level of user for the application 240. Similarly application of at least decryption may be dependent on an authentication of a user via a security system of the first network 210; if a user is disabled or deleted from the security system of the first network, that user may be denied access to the application 240 and/or prevented from decrypting (and/or encrypting) data.

Security Broker Example in Use

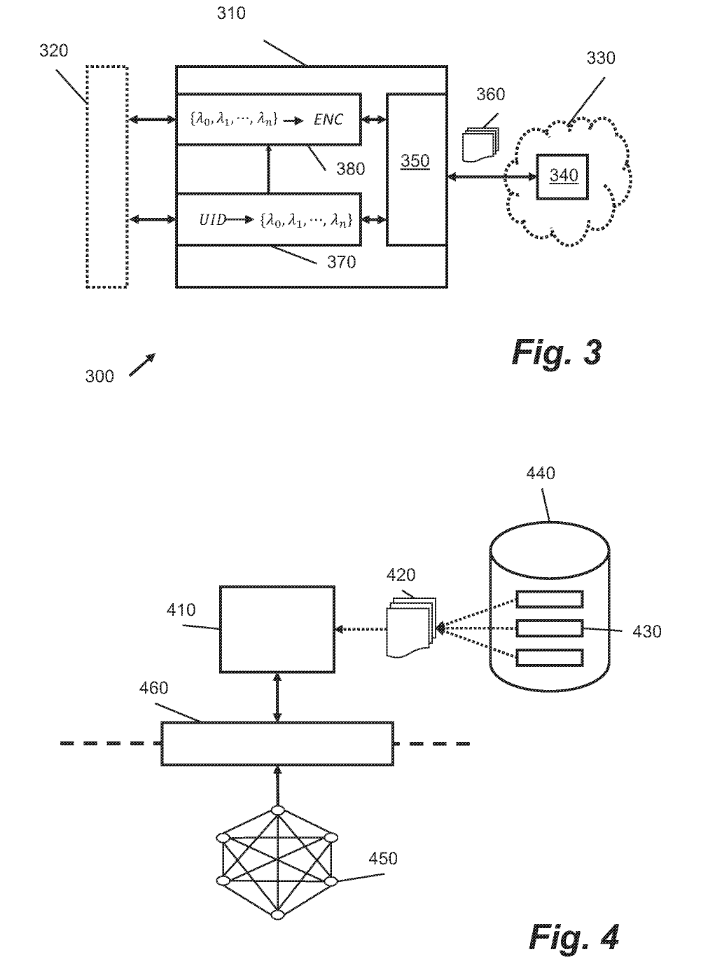

FIG. 3 shows a schematic diagram of an example 300 of a security broker 310. Security broker 310 may comprise an implementation of security broker 260 as shown in FIG. 2. Security broker 310 is shown as a component in secure communication with a first network 320 and having access to a second network 330. Security broker 310 may access the second network 330 via an interface 350. Interface 350 is arranged to receive data record definitions for an application 340 where the data record definitions specify one or more properties that define how data is stored by the application 340. Security broker 310 is arranged to supply encrypted data to the application 340 via interface 350 and is also arranged to supply decrypted data to a computing device from the first network 320.

FIG. 3 shows a security controller 370 and an encryption module 380 as components in the security broker 310 coupled to interface 350. Prior to performing any operations such as encryption, security broker 310 may be arranged to register and/or authenticate users via an authentication service, for example using a service such as Active Directory®. According to another example, authentication of a user to the security broker 310 may be performed via authentication to a server on the first network or through a separate authenticating means such as a Single Sign-On. For example, security controller 370 may be arranged to authenticate users associated with the first network 320 using an authentication service for the first network 320 to determine valid user identities. These user identities may then be mapped to security parameters. This may be performed as described above, e.g. by applying constraints and/or options indicated in the data record definitions and/or by mapping user roles and/or privileges. For example, the application 340 may provide an interface, such as an API, for handling session management such as the creation and deletion of a session, wherein a session is initiated once a user is authenticated by the security broker 310 via the authentication service used by the first network. According to an example, the user identities are indicative of a set of permissions applied by a security system of the first network that restrict one or more actions that are available to a user of a computing device of the first network. Security controller is shown taking a user identity UID as input and mapping the input on to one or more security parameters {λ_0, λ_1, . . . , λ_n}. For example, a user identity may comprise a user and/or a group identifier, wherein the user and/or group is associated with a set of permissions. These permissions may relate to permissions for one or more of reading, writing, executing, modifying and viewing data. The permissions may be defined in relation to one or more file, directory and/or network resources on the first network and may cover data and metadata, e.g. file attributes. The security parameters comprise parameters which act as input to an encryption scheme handled by the encryption module 380. Encryption module 380 is arranged to take the security parameters {λ_0, λ_1, . . . , λ_n}, and generate a key for encrypting and decrypting data in accordance with the security level indicated by the security parameters.

Mapping user identities, e.g. as authenticated using an authentication service, to parameters for an encryption scheme may be performed in association with a mapping of permissions for the application 340. These permissions, and/or the encryption scheme, may form part of a security scheme that is applied by the security broker 310. For example, different user identities, including group identities, may be mapped to different application functions and/or features, e.g. used to restrict one or more actions that are available to said one or more users by the application 340.

Mapping user identities simplifies the configuration of security settings for the application 340. For example, if a user leaves an organization associated with the first network 320 there is no longer a user identity for the first network 320 that may be mapped to one or more parameters for a security scheme. Similarly, if a user identity is disabled, e.g. if a user account has been compromised, then this may be performed with regard to the first network 320 and be automatically mapped, by the security controller 370, to disable the user with regard to the application 340. This reduces a security risk. If security access is handled separately by the application 340, e.g. as per comparative examples, this may present a security risk as a user may be disabled on the first network 320 but still able to access sensitive data via the application 340.

In one use case, a user with user identity UID makes a request to store data using application 340. For example, the user may wish to store a file using application 340 and/or measurement data may be transmitted from the user's computing device. This request is routed via the security broker 310. This may be performed by appropriate network address mapping within the first network 320, e.g. may be applied by one or more network devices and/or by an agent monitoring network requests that is running on a user computing device. In one example the application 340 is configured to serve content via the security broker 310 to the user with user identity UID. For example, a web page served from the application (e.g. www.application.com) may contain JavaScript logic to fetch data via the security broker 310 (e.g. via http://internal.broker.company-x.com). The request may comprise data that indicates the user identity and/or this may be inserted by said network devices or agents on the user computing device. Security controller 370 is then instructed to map the user identity associated with the user onto security parameters for the encryption scheme being implemented in encryption module 380. For example, this may comprise retrieving security parameters based on a previously defined mapping that is stored in configuration data for the security broker 310, e.g. a lookup table or the like. In the present example, when data for encryption is sent from the first network 320 via the security broker 310, the data is received at the encryption module 380 and is encrypted before being passed, via interface 350 to the application 340. The data is stored by the application 340 according to the data record definitions.

In certain cases, no user agent on a computer device may be required to perform routing via the security broker 310. For example, an initial response may be served to a user of the computer device and within that response may be several additional requests that are directed to an appropriate security broker 310 to retrieve user data. In one case, standard domain name server (DNS) routing is used to allow a user's computing device to locate the security broker 310 addressed in the secondary request.

In certain cases, as shown for example in FIG. 2, any portion of the request that does not comprise data to be encrypted may be routed directly to the application 340 without passing through the security broker 310. For example, certain requests may relate to system data for the application 340 that is not sensitive and/or user interface components that do not comprise sensitive data. Different portions of a user interface, e.g. a web page, may thus be routed via different paths.

In another use case, when a user on the first network 320 requires access to encrypted data stored by the application 340, a response to a request is sent via interface 350 to the encryption module 380, which is then able to perform a decryption operation. The decryption operation is based on the same security parameters that are used for the previous act of encryption, e.g. a user identity may be derived from the request for encrypted data and/or the response with the encrypted data and this may be used to retrieve the appropriate security parameters. The unencrypted data is then passed to the user computing device in first network 320. In one case, any request for encrypted data from the application may be routed via the security broker 310. In another case, an initial request for encrypted data may be routed over the second network, e.g. over an unsecure connection, but the application 340 may be configured to route any response via the security broker 310 for decryption. In yet another case, if encryption and decryption are performed on a user computing device that has been configured by the security broker 260, e.g. via an agent installed on the user computing device, the agent may monitor network communications so as to performing the routing and encryption operations as described herein. In any case, encryption and/or decryption are performed transparently for a user of a computing device in the first network 320, e.g. the user may simply access application 340 via a browser as per any other web service.

In one implementation, a user request for data may comprise a JavaScript call from the user's computer device to the security broker 310. This JavaScript call may comprise their user identity (e.g. UID above) and session token. The token, user identity, and a computer device identifier may then be used to verify the session's validity. Upon successful verification, a security broker session identifier (SID) may be used to retrieve the security configuration mapping of roles and permissions between the application 340 and the first network 320.

In FIG. 3 encryption module 380 is shown as part of security broker 310. It is possible for security broker 260 to access an encryption module 380 through a secure connection separate from the security broker 310 itself. In this case, security broker 310 may be arranged to instruct an encryption module 380 to encrypt or decrypt data according to the encryption scheme configured by the security broker 310. In such a case it is not necessary, in use, for the security broker to possess keys or material related to the keys to encrypt or decrypt data, however it is necessary to authenticate the security broker to prevent unauthorised decryption of encrypted data by the encryption module. Examples of encryption modules which may be implemented in this fashion include Tamper-Proof Modules (TPM) and Hardware Security Modules (HSM). In further examples, as described previously, the encryption module 380 may be implemented in the first network 320 on a user computing device.

In one implementation of the security broker 310 of FIG. 3, the security broker 310 may comprise an interface arranged to receive data indicative of user identities corresponding to users on the first network 320. This interface may comprise a graphical user interface, a command-line interface and/or an API. The interface may be arranged to perform remote API queries on one or more network security systems used on the first network 320. In certain cases, the interface may be arranged to receive commands from a computing device operated by a system administrator of the first network. In one or more of these cases, data retrieved via the interface may be used to indicate a mapping between security data, such as data indicative of user identities, and a set of parameter values for the properties that define how data is stored by the application.

In certain cases the security broker 310 is configured such that it does not store or cache either encrypted or unencrypted data. For example, the security broker 310 may be configured to perform pass-through encryption as data to be encrypted is received from the user computing device, and pass-through decryption as encrypted data from the application is decrypted for supply to the user computing device. In one example, this may be implemented by performing cryptographic operations via an agent operating on the user computing device that is under control of the security broker.

Remote Network Application Example

FIG. 4 shows a schematic diagram of an application 410 which may be used in conjunction with the systems shown in FIGS. 2 and 3. The application 410 may comprise computer program code that is arranged to be stored in system memory and processed by one or more processors of at least one server computing device. As described in relation to the other Figures, the at least one server computing device is accessible from a network 450 but resides in an insecure and/or untrusted network domain. In FIG. 4, data record definitions 420 corresponding to data records 430 that are to be, or that are being, stored by the application 410 in a data store 440 are sent via the application to security broker 460. The data record definitions specify one or more properties that define how data is stored by the application. The data record definitions may comprise data indicating user security, roles, policies and/or permissions as applied by the application 410. Security broker 460 is configured to receive the data record definitions 420 from the application 410. As in previous FIGS. 1 to 3, a computing device on network 450 accesses the application 410 through the security broker 460. The computing device is trusted on the network 450.

In the example of FIG. 4, data sent from the computing device on network 450 is sent through the security broker 460 and is encrypted for each relevant data record field in accordance with the data record definitions 420 before being stored in data store 440. The data is not able to be decrypted by the application as it does not have access to the decryption key configured by the security broker. According to an example, application 410 may also store content excluding data defined in the data record definitions 420. In such a case, this data may be passed directly to the computing device in network 450. For example, as shown in FIG. 2, it is possible for the first network to also receive data from the application without passing through the secure broker, unencrypted. Routing of data via the security broker may be configured as described above.

### Example Methods

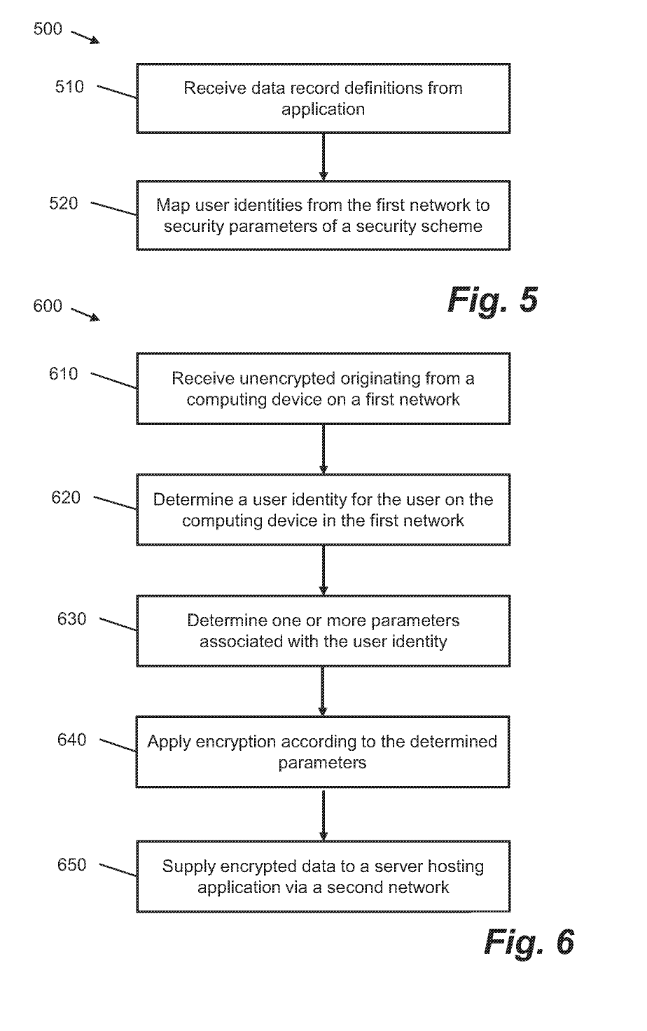

FIG. 5 shows a flow chart of a method 500 for configuring a security scheme according to an example. The security scheme may be used as described above, e.g. to encrypt data for supply to an application via a second network and to decrypt data from the application for supply to a computing device in a first network. In this case it may comprise an encryption scheme. At block 510, data record definitions are received. These may be received at an interface of a security broker such as interface 350 shown in FIG. 3. The data record definitions may be received from the application, or in certain variations, an external third party. At block 520 security data for the first network is mapped to parameters for a security scheme to be applied to data for storage by the application. For example, certain data records stored by the application may be deemed less sensitive and require low strength encryption or no encryption at all. Other records may be deemed sensitive and require high-strength encryption. Block 520 may comprise authenticating a user identity using an authentication or security system of the first network. Selected encryption levels and/or user permissions with regard to the application may be retrieved if the user is authenticated. In certain cases, parameters may depend on a level and/or group of an authenticated user, e.g. permissions for the user on the first network. For example, a system user may require a certain field to be encrypted using 256-bit encryption for authenticated users and deny a particular group of user's access to a particular set of data fields.

In one variation, more expressive forms of encryption such as identity based encryption may be implemented. In such a case not only the strength of encryption (e.g. 128-bit or 256-bit) may be specified by user parameters but also, cryptographic keys may be used to control access to data records based on identities of users. Such an encryption scheme would allow a system level user to generate keys for standard users who subsequently be able to decrypt only those data records encrypted under keys matching their identities. Any parameters are configured to comply with the available constraints and/or options as defined with the data record definitions.

According to an example the mapping may comprise first mapping a user identity to a user security profile. The user security profile may specify data indicative of a security level that is available for use by the application. For example, the application may have three security levels, wherein one of these level may be assigned to a user of the application. These security levels may be indicated in a number of user security profiles. The user security profile is then used to implement permissions for the user with regard to the application.

FIG. 6 shows a flow chart of a method 600, according to an example, of supplying encrypted data to a server computing device via a second network. The method 600 may be applied in the context of the systems of FIGS. 2 to 4. The method 600 may be used in conjunction with the method of configuring a security scheme shown in FIG. 5. At block 610 unencrypted data originating from a computing device in the first network is received. At block 620 a user identity for the user on the computing device in the first network is determined. For example, this may be performed by authenticating the user via a security system of the first network. At block 630 one or more parameters that are associated with the user identity are determined, for use by the security scheme. At block 640 encryption is applied according to the determined parameters. At block 650 the encrypted data is supplied to the server computing device via a second network for storage by an application. The encryption stage 640 may be implemented on a system as in FIG. 3 or a system which has a separate encryption module from the security broker, however in both cases the application does not have access to the unencrypted data records received at block 610 and is only supplied with the data records after encryption at block 650.

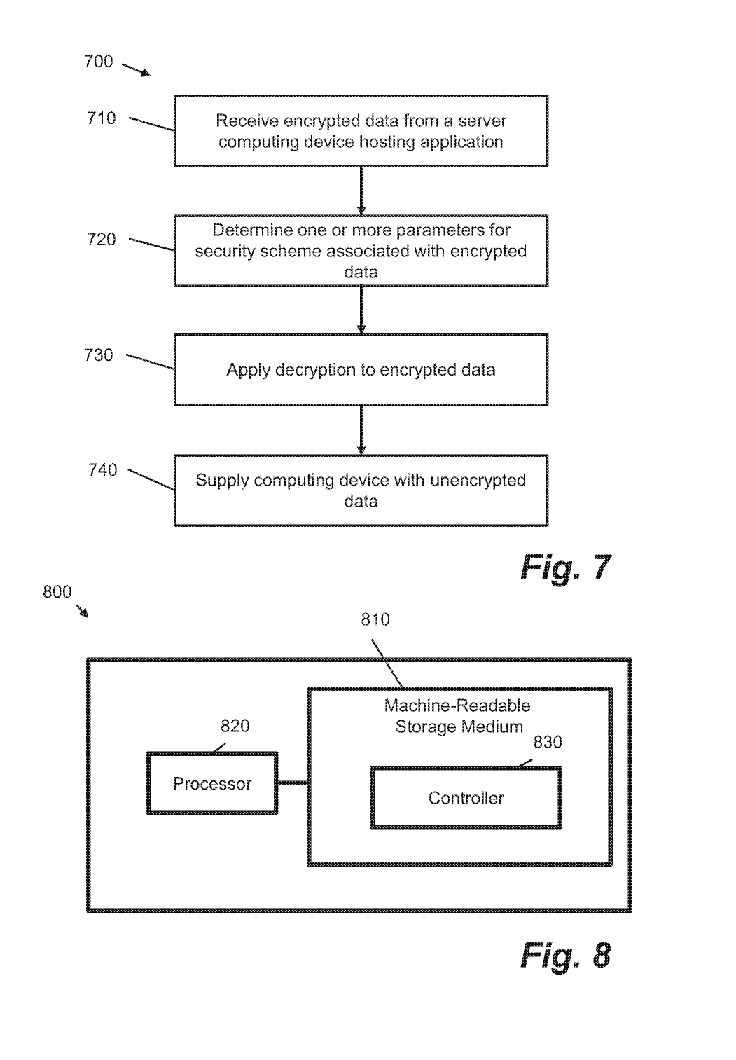

FIG. 7 shows a flow chart of a method 700 according to an example. The method 700 may be applied in the context of the systems of FIGS. 2 to 4. The method may be used to supply a computing device on a first network with unencrypted data from an application. At block 710 encrypted data is received from a server computing device hosting the application. In one case the encrypted data may be received by a security broker coupled to a second network. In another case, the encrypted data may be received at an encryption module under control of the security broker. At block 720 one or more parameters for the security scheme that are associated with the encrypted data are determined. For example, these may be retrieved from data stored by the security broker in response to information that accompanies the data. At block 730, a decryption algorithm is applied to encrypted data received from the application in accordance with the determined parameters. Such a decryption algorithm may take as input data records that are encrypted under one or more parameters corresponding to one or more users on the first network and one or more secret keys for decryption, and may output a decrypted data record. At block 740, decrypted data records are supplied to the computing device on the first network.

In the case of a security broker, such as that shown in FIG. 3, implementing this method, the security broker may be arranged to receive encrypted data from the application, for example the security broker may have access to an encryption module. In one case, a request to an application received at a security broker to obtain encrypted data records may be deconstructed into a first request for the security broker to instruct the application to retrieve encrypted data records and a second request to instruct the security broker to decrypt the data records using the available encryption module.

In certain cases, read and/or write access may be associated with a particular security role and/or a particular user. In certain cases, the application may be granted access to secured, e.g. encrypted, data such that it may perform analysis on said data. In certain cases the application may only be granted read access to certain data. The application may also need to be authenticated via the security system of the first network in order to access encrypted data. For example, the application may be assigned a user and/or security profile within the first network. As such, a system user of the first network has the ability to restrict access to the data by the application, e.g. access by the application may be revoked in the event of a change in application or a security breach at the application.

According to one example, prior to receiving any encrypted data, a request to access encrypted data may be received at a security broker from a computer device in the first network. The request may be a secure or unsecure HyperText Transfer Protocol (HTTP) request from a browser and/or agent operating on the computer device. The request may be an adapted request for data for the application, e.g. a re-routed request, and/or a separate request that is generate when a request for encrypted data is made by the user on the computer device. In this case, based on the received request, the user identity of the user of the computing device is determined, e.g. via an authentication routine such as a network domain login. For example, the request may comprise a user and/or group identifier. Following the determination, parameters for the encryption scheme corresponding to the user identity are retrieved. A request is then sent to the server computing device hosting the application in the second network for the encrypted data associated with the request from the computing device.

Certain examples as described herein have an advantage of guaranteeing that sensitive user data never leaves the user network without being encrypted. An application that is hosted outside of a user's network is not able to access the encrypted data stored therein. Moreover, security parameters such as cryptographic keys for the encryption schemes are not transmitted and/or held by devices outside of the control of the first network, e.g. are not transmitted over, and/or held upon, unsecure or untrusted networks. Certain examples described herein allow for data to be transparently encrypted and decrypted from a user viewpoint. Moreover data is always presented to the user in an unencrypted format, improving usability. Certain examples herein may be configured quickly and easily by mapping security data, such as authenticated user identities on a secure user network, to parameters for an encryption scheme to be provided. The selection of these parameters may be customized based on the mapping and options provided by the application, as such a security broker as described herein may provide increased flexibility to the user for securing their data and a level of customization, while ensuring compatibility with a cloud-based application and how it stores data. By mapping existing user identities a system administrator may automatically configure the security of applications outside of their control. The user need not be involved in this configuration; their existing security policies may enable appropriate application settings to be selected. For example, a user need not do anything to opt-in or opt-out of the encryption, which may be centrally managed.

This means that third-party applications can be managed from a security perspective, while still mitigating the risks associated with accessing applications in a network environment with regions of differing security properties. Advantageously, the methods and systems disclosed herein may be used in conjunction with a wide range of network environments with complex security constraints, without reducing flexibility for users. In certain cases, a user in the first network is given control over the level of security to be applied to data being supplied to an application in the second network. Such a user also has control over the security methods applied to their data. This occurs regardless of the application's level of security. This may be seen as an inversion of the control pattern that is applied in comparative implementations of third party applications.

Certain methods and systems as described herein may be implemented by one or more processors that processes program code that is retrieved from a non-transitory storage medium. For example, the one or more processors may form part of one or more server, user and/or embedded computing devices. FIG. 8 shows an example 800 of a device comprising a machine-readable storage medium 810 coupled to a processor 820. Machine-readable media 810 can be any media that can contain, store, or maintain programs and data for use by or in connection with an instruction execution system. Machine-readable media can comprise any one of many physical media such as, for example, electronic, magnetic, optical, electromagnetic, or semiconductor media. More specific examples of suitable machine-readable media include, but are not limited to, a hard drive, a random access memory (RAM), a read-only memory (ROM), an erasable programmable read-only memory, or a portable disc. In FIG. 9, the machine-readable storage medium comprises program code 930 to effect one or more controllers for implementing any of the previously described devices and/or methods.

The above examples are to be understood as illustrative examples. Further examples are envisaged. It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

What is claimed is:

1. A security broker in secure communication with a first network and having access to a second network external to the first network, the first network having a first level of security and the second network having a second level of security, the first level of security being different from the second level of security, the security broker comprising:
an interface arranged to receive data record definitions for an application, the application being accessible using the second network, the data record definitions specifying one or more properties that define how data is stored by the application;
a security controller arranged to map security data for the first network to one or more parameters for a security scheme to be applied by the security broker to data for storage by the application, the security controller being arranged to configure the security scheme to comply with the data record definitions; and
wherein the security broker is arranged to supply data encrypted using the security scheme to the application for storage using the second network and is arranged to supply data from the application that is decrypted using the security scheme to a computing device associated with the first network.

2. The security broker of claim 1, wherein the security scheme comprises an encryption scheme and the security controller is arranged to instruct an encryption module in secure communication with the first network to encrypt and decrypt data according to the parameters of the encryption scheme.

3. The security broker of claim 1, wherein,
the first network comprises at least one user computing device, the at least one user computing device being accessed by at least one user with a corresponding user identity for the first network,
the security controller is arranged to map a user identity for said at least one user to one or more parameters for the security scheme for the at least one user,
the security broker is arranged to receive a request originating from the at least one user computing device and determine the user identity of the at least one user so as to retrieve the one or more parameters for the at least one user,
the security broker is arranged to encrypt data originating from the at least one user computing device according to the one or more parameters for the at least one user and to supply said data to the application, and
the security broker is arranged to decrypt data originating from the application according to the one or more parameters for the at least one user and to supply said data to the at least one user computing device.

4. The security broker of claim 1, comprising:
an interface arranged to receive said security data for the first network,
the security data being indicative of a set of permissions applied by a security system of the first network that restrict one or more actions that are available to a user of a computing device of the first network,
said interface being arranged to receive one or more commands from a computing device operated by a system administrator of the first network, said commands indicating a mapping between the security data and a set of parameter values for the one or more properties that define how data is stored by the application.

5. The security broker of claim 1, wherein the interface is arranged to receive configuration data from the application indicating one or more user security profiles that are used by the application and wherein the security broker is arranged to map a given user identity for the first network to a particular user security profile in the one or more user security profiles.

6. A method comprising:
receiving data record definitions from at least one server computing device, the at least one server computing device hosting an application, the data record definitions specifying one or more properties that define how data is stored by the application; and
mapping security data for a first network to one or more parameters for a security scheme to be applied to data for storage by the application, including configuring the security scheme to comply with the data record definitions
the at least one server computing device being communicatively coupled to a second network,
the at least one server computing device being accessible from the first network,
the first network having a first level of security and the second network having a second level of security, the first level of security being different from the second level of security,
wherein the security scheme is configured to encrypt data for supply to the application via the second network and is configured to decrypt data from the application for supply to a computing device associated with the first network.

7. The method of claim 6, comprising:
receiving unencrypted data originating from the computing device, the computing device being in the first network;
determining a user identity for a user of the computing device;
determining one or more parameters for the security scheme that are associated with the user identity;
applying encryption according to said determined one or more parameters of the security scheme; and
supplying the encrypted data to the server computing device via the second network for storage by the application.

8. The method of claim 6, wherein mapping security data for the first network to one or more parameters for an security scheme comprises:
mapping a user identity to a user security profile, the user security profile providing data indicative of a recommended level of security;
selecting one or more security parameters for an security scheme based on the recommended level of security indicated by the user security profile data.

9. The method of claim 6, comprising:
determining whether at least a portion of a request from the computing device comprises data to be encrypted using the security scheme;
routing any portion of the request that comprises data to be encrypted via a security broker in secure communication with the first network and communicatively coupled to the second network.

10. The method of claim 9, comprising:
routing any portion of the request that does not comprise data to be encrypted to the server computing device.

11. The method of claim 6, comprising:
receiving encrypted data from the server computing device via the second network,
determining one or more parameters for the security scheme that are associated with the encrypted data;
applying decryption according to said determined one or more parameters of the security scheme; and
supplying the computing device with the unencrypted data.

12. The method of claim 10, comprising, before receiving encrypted data:
receiving a request from the computing device, the request being associated with encrypted data that is stored by the application;
determining a user identity for a user of the computing device that is associated with the request;
retrieving one or more parameters for the security scheme based on the user identity;
sending a request to the server computing device for the encrypted data that is associated with the request from the computing device,
wherein determining one or more parameters for the security scheme comprises using the retrieved one or more parameters.

13. A computer program comprising computer program code arranged to, when loaded into system memory and processed by one or more processors of at least one server computing device, causes said processers to implement an application, the application being arranged to:
receive a request for one or more data record definitions from a computing device,
the data record definitions specifying one or more properties that define how data is stored by the application,
the computing device being in secure communication with a first network and the at least one server computing device being accessible from the first network using a second network, the first network having a first level of security and the second network having a second level of security, the first level of security being different from the second level of security, in response to the request, send said one or more data record definitions to the computing device;
in response to the request for one or more data record definitions, send the one or more data record definitions to the computing device;
receive encrypted data via the second network for storage in compliance with the one or more data record definitions, the application being unable to decrypt the encrypted data;
receive a request for access to the encrypted data from the second network, the request originating from the first network; and
in response to the request for access to the encrypted data, retrieve said encrypted data and send said encrypted data to the computing device via the second network,
wherein the encrypted data is decrypted by way of the computing device for supply to the first network.

14. The computer program of claim 13, wherein the application is arranged to:
receive a request for access to unencrypted data from the first network; and
in response to the request for access to the unencrypted data, retrieve said unencrypted data and send said encrypted data to the first network.

15. The computer program of claim 13, wherein:
the application is arranged to access at least one storage device communicatively coupled to the at least one computing device, the at least one storage device storing a data store;
the one or more data record definitions comprise at least values associated with a schema for the data store.

16. The computer program of claim 13, wherein:
the application is arranged to implement one or more user security profiles, the one or more security profiles being indicative of a set of permissions applied by the application that restrict one or more actions that are available to a user of the application;
the application is arranged to send data indicative of the one or more user security profiles to the computing device.

17. A security system comprising:
a user computing device in a first network, the first network having a first level of security;
a security broker securely coupled to the first network and in communication with a second network, the second network having a second level of security, the second level of security being different from the first level of security; and
an application implemented by at least one server computing device in a second network, the application being configured to supply configuration data to the security broker;
wherein the security broker is arranged to use the configuration data from the application to configure a security scheme to be applied by the security broker,
wherein the security broker is arranged to encrypt data originating from the user computing device according to the security scheme and to send said encrypted data to the application for storage,
wherein the security broker is arranged to configure the security scheme according to security data for one or more users of the user computing device, the security data being indicative of a set of permissions applied on the first network that restrict one or more actions that are available to said one or more users.

18. The security system of claim 17, wherein the security scheme comprises an encryption scheme and the security broker is arranged to decrypt data originating from the application according to the encryption scheme and to send said decrypted data to the user computing device.

19. The security system of claim 17, the security scheme comprises an encryption scheme and wherein the user computing device comprises an agent arranged to encrypt data for supply to the application according to the encryption scheme configured by the security broker.

20. The security system of claim 17, wherein:
the security broker is arranged to define data indicating that the security scheme is to be applied to one or more data fields indicated in the configuration data, and
the user computing device comprises an agent arranged to monitor requests sent to the application from the user computing device, the agent being arranged to apply encryption according to the security scheme responsive to a determination that the request comprises data associated with said one or more data fields.
